(19) United States
(12) Patent Application Publication
(10) Pub. No.: US 2009/0258556 A1
(43) Pub. Date: Oct. 15, 2009

(54) COVERING MATERIALS FOR VEHICLE SEATS

(75) Inventors: Kousuke TANAKA, Nagoya-shi (JP); Akihiro MATSUYAMA, Seto-shi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/419,398

(22) Filed: Apr. 7, 2009

(30) Foreign Application Priority Data
Apr. 9, 2008 (JP) 2008-101114

(51) Int. Cl. B32B 27/12; B05D 5/12

(52) U.S. Cl. 442/110; 427/58

(57) ABSTRACT

A covering material for a vehicle seat may include a base material constructed of polyester fiber containing fabric and an electrically conductive agent applied to the base material. The electrically conductive agent may include a copolymer of polyethylene terephthalate and polyethyleneglycol.

This application claims priority to Japanese patent application serial number 2008-101114, the contents of which are incorporated herein by reference.

### BACKGROUND OF THE INVENTION

The present invention relates to covering materials for vehicle seats. More particularly, the present invention relates to antistatic covering materials for vehicle seats.

A covering material for a vehicle seat is already known. Such a covering material is taught, for example, by Japanese Laid-Open Patent Publication No. 2001-98461. The covering material is constructed of fabric that is essentially made of polyester fibers. However, the covering material can easily generate static charge by friction because the polyester fibers are electrostatic charging materials.

In order to prevent the covering material from generating static charge, a special treatment agent, i.e., water absorptive polymers (polymers containing water absorptive groups) or amine compounds, are adhered to the polyester fibers via polyurethane, so as to provide increased electrical conductivity to surfaces of the polyester fibers.

The covering material constructed of the fabric that is made of polyester fibers thus treated can be prevented from generating static charge. That is, the covering material can have antistatic performance. However, such a treatment agent may generally decrease or deteriorate inherent properties (e.g., strength, expandability, durability, light resistance, wrinkle resistance and touch) of the covering material (the fabric).

### BRIEF SUMMARY OF THE INVENTION

For example, in one aspect of the present invention, a covering material for a vehicle seat may include a base material constructed of polyester fiber containing fabric and an electrically conductive agent applied to the base material. The electrically conductive agent may include a copolymer of polyethylene terephthalate and polyethyleneglycol.

The base material of the covering material thus constructed can have increased conductivity due to the electrically conductive agent applied thereto. The increased conductivity of the base material is believed to be due to an affinity of polyethylene terephthalate for the polyester fiber and an electrolytic property of polyethyleneglycol. As a result, the covering material can be effectively prevented from generating static charge. That is, the covering material can have antistatic performance. In addition, such an electrically conductive agent does not decrease or deteriorate inherent properties of the covering material (the base material).

In one embodiment of the present invention, the electrically conductive agent is applied to the base material at a rate not less: than 0.5 g/m² as solid content. The base material thus treated can have sufficient electrical conductivity for a long period of time. As a result, the covering material can have the antistatic performance for a long period of time.

Other objects, features and advantages of the present invention will be readily understood after reading the following detailed description together with the claims.

### BRIEF DESCRIPTION OF THE DRAWINGS

FIG. 1 is a flow chart of a representative manufacturing process of a covering material for a vehicle seat according to a representative embodiment of the present invention;

FIG. 2 is an explanatory view of a dipping step in the manufacturing process; and

FIG. 3 is a graph of a result of a test of resistance to performance deterioration (conductivity deterioration) by friction, which illustrates a relation between an application amount of an electrically conductive agent and a rate of increase of a volume resistivity value.

### DETAILED DESCRIPTION OF THE INVENTION

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

In the following, a detailed representative embodiment of the present invention will be described.

A covering material for a vehicle seat according to a representative embodiment of the present invention is constructed of a base material and an electrically conductive agent that is applied to the base material. The base material is constructed of fabric that is essentially made of polyester fibers, which fabric will be referred to as polyester fiber containing fabric. In this embodiment, the polyester fiber containing fabric may include fabric that is made of the polyester fibers only and fabric that is made of the polyester fibers and different types of fibers. Further, the polyester fiber containing fabric may have various forms, e.g., woven fabric, jersey knit, tricot fabric, unwoven fabric, moquette and knit fabric. In addition, the polyester fiber containing fabric may include fabric that is provided with a backing resin layer in order to increase combustibility, resistance to ravel or resistance to damage.

The electrically conductive agent may function to increase electrical conductivity of the base material, thereby preventing the covering material from generating static charge. The electrically conductive agent of the present embodiment may preferably contain copolymers of polyethylene terephthalate (PET) and polyethyleneglycol (PEG), which copolymers have the following general formula:

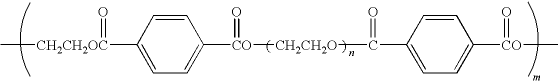

In the covering material thus constructed, the electrically conductive agent can provide increased conductivity to the base material. As a result, the covering material can be prevented from generating static charge. That is, the covering material can have antistatic performance. In addition, such an electrically conductive agent does not decrease or deteriorate inherent properties (e.g., strength, expandability, durability, light resistance, wrinkle resistance and touch) of the covering material (the base material).

In order to apply or coat the electrically conductive agent to the base material, an aqueous solution in which the electrically conductive agent is dispersed may preferably be formulated. The aqueous solution of the electrically conductive agent thus formulated may preferably be directly applied to the base material by known application methods, e.g., dipping (immersion) and spray coating. Thus, the electrically conductive agent can be applied or coated to the base material.

The electrically conductive agent may preferably be applied or coated to the base material at a rate of 0.2-5 g/m² as solid content, more preferably 0.5-5 g/m², and most preferably 0.8-5 g/m². If an electrically conductive agent application amount is less than 0.2 g/m², the base material will likely not have sufficient electrical conductivity. As a result, the covering material cannot be effectively prevented from generating static charge. To the contrary, if the electrically conductive agent application amount is greater than 5 g/m², the inherent properties of the covering material (the base material) can be possibly decreased or deteriorated. Further, if the electrically conductive agent application amount is 0.5-5 g/m², the base material can have the sufficient electrical conductivity for a long period of time. As a result, the covering material can have the antistatic performance for a long period of time. Further, if the electrically conductive agent application amount is 0.8-5 g/m², the base material can have the sufficient electrical conductivity for a longer period of time. As a result, the covering material can have the antistatic performance for a longer period of time.

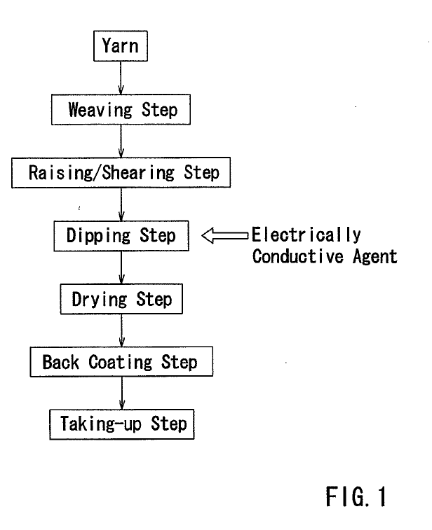

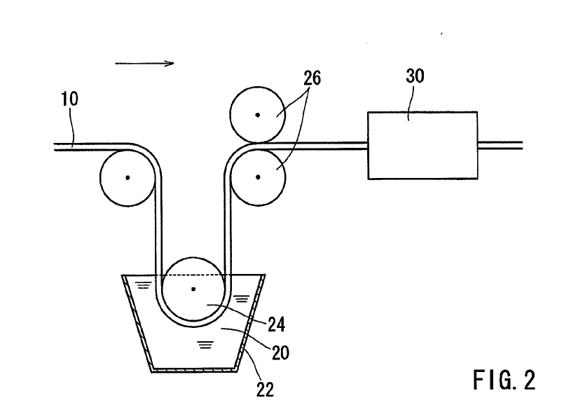

Next, a representative manufacturing process of the covering material will be described with reference to FIGS. 1 and 2. Further, in this embodiment, the manufacturing process of the covering material may preferably be successively performed in a single manufacturing line.

First, as shown in FIG. 1, yarn that is spun from the polyester fibers and the different types of fibers (which may be simply referred to as “fibers”) may preferably be woven into the polyester fiber containing fabric (which may be simply referred to “fabric”) in a weaving step. The woven fabric is then raised and sheared in a raising/shearing step, so as to be surface treated.

Thereafter, the fabric thus formed is immersed or dipped into the aqueous solution of the electrically conductive agent in a dipping step, so as to be applied with the electrically conductive agent. In particular, as shown in FIG. 2, the fabric (which is indicated by a reference numeral 10) is introduced into a container 22 filled with the aqueous solution of the electrically conductive agent (which is indicated by a reference numeral 20) while guided by a guide roller 24. Subsequently, the dipped fabric is squeezed with a pair of squeezing rollers (nip rollers) 26.

The squeezed fabric is then transferred to a drying step. In particular, as shown in FIG. 2, the fabric is introduced into a drying chamber 30 and is dried therein. Optionally, the dried fabric is then transferred to a back coating step in order to apply the backing resin layer thereto.

The fabric thus treated is taken up around a take-up roller in a take-up step. Thus, the covering material (i.e., the fabric applied with the electrically conductive agent) can be manufactured.

Further, in the dipping step, the aqueous solution of the electrically conductive agent may preferably be formulated so as to contain the electrically conductive agent in concentrations of 0.15-1.5 wt %. Further, in the drying step, the fabric may preferably be dried at 60-110° C. If the fabric is dried at temperatures greater than 110° C., the fabric (the polyester fibers) can be susceptible to be color faded or discolored. That is, the fabric can have an increased color migration property. This is believed to be due to the phenomenon that chemical binding of polyester molecules can be loosened when the fabric is heated to the temperatures greater than 110° C., so that dyestuff molecules can be easily released from the polyester molecules. To the contrary, if the fabric is dried at temperatures lower than 60° C., it takes too long for the fabric to be dried.

In the manufacturing process of the present covering material, a heat setting step in a manufacturing process of a conventional covering material (a conventional manufacturing process) is simply replaced with the dipping step and the drying step. As will be recognized, the heat setting step means a step in which the base material is heated under pressure in order to remove wrinkles. However, a chamber used in the heat setting step in the conventional manufacturing process can be used as the drying chamber 30 of the drying step in the present manufacturing process. Therefore, the present covering material can be easily manufactured using a manufacturing line for manufacturing the conventional covering material (a conventional manufacturing line). That is, the present covering material does not need a special manufacturing line. As a result, the present covering material can be manufactured at low costs.

Naturally, various changes and modifications may be made to the present embodiment without departing from the scope of the invention. For example, in this embodiment, the covering material is continuously manufactured using a single manufacturing line. However, the covering material can be separately manufactured using two or more manufacturing lines.

### EXAMPLES

Examples of the present invention will now be described. Further, the following examples are illustrative and should not be construed as limitations of the invention.

### Initial Inherent Property Test

In an initial inherent property test, one example covering material (Example 1) was prepared by utilizing a fabric piece that is essentially made of the polyester fibers and a commercially available electrically conductive agent “ELENITE A73R” (Takamatsu Yushi Kabushiki Kaisha, Japan) as the electrically conductive agent. Further, the electrically conductive agent contained the copolymers of polyethylene terephthalate (PET) and polyethyleneglycol (PEG) as a main ingredient (an effective ingredient). In particular, the fabric piece was dipped into an aqueous solution of the electrically conductive agent that was diluted to 0.6 wt %, so as to be impregnated with the electrically conductive agent. Thereafter, the fabric piece was squeezed with the squeezing rollers and was then dried at a temperature of 110° C. for two minutes, thereby forming the example covering material (Example 1) having an electrically conductive agent application amount of 0.8 g/m². Also, one control covering material (Control) was prepared by utilizing the fabric that is not applied with the electrically conductive agent.

With regard to each of Example 1 and Control thus formed, a volume resistivity value, tensile strength, an extension rate under constant load, a setting rate under constant load, and combustibility were determined.

The volume resistivity value was determined at a temperature of 11.9° C. and humidity of 25% using the testing method defined in Japanese Industrial Standards (JIS K6911). As will be appreciated, the covering material having a reduced volume resistivity value may have increased electrical conductivity, thereby providing increased antistatic performance.

The tensile strength was determined at a rate of pulling of 200 mm/minute using the testing method defined in Japanese Industrial Standards (JIS L1098).

In a test for determining the extension rate under constant load, Example 1 and Control were cut out lengthwise and widthwise, so as to form two different types of (lengthwise and widthwise) rectangular test pieces each having a width of 80 mm and a length of 250 mm. Each of the test pieces was longitudinally centrally marked with gauge points, so as to have a gauge distance of 100 mm. The test piece thus formed was attached to an extension rate measuring machine. In particular, a predetermined upper pulling portion of the test piece was secured to an upper fixed clamp of the machine, so that the test piece was vertically suspended therefrom. Conversely, a predetermined lower pulling portion of the test piece was coupled to a lower movable clamp of the machine. The lower movable clamp was provided with a weight such that the test piece could be vertically applied with a load or weight of 10 kg. Further, the upper and lower pulling portions were determined such that a distance therebetween was set to 160 mm. After the test piece was applied with the load (10 kg) for ten minutes, the gauge distance (L1) of the test piece was measured using a vernier caliper. The extension rate under constant load (E) was calculated using the following calculating formula:

E(%)=[(L1−100)/100]×100

L1: Gauge distance in ten minutes after the test piece was loaded (mm)

In a test for determining the setting rate under constant load, the test pieces used in the previous test (the test for determining the extension rate under constant load) were used. In particular, after the gauge distance (L1) of each of the test pieces was measured, the test piece was removed or detached from the extension rate measuring machine. The removed test piece was then left for ten minutes on a horizontally positioned table. Thereafter, the gauge distance (L2) of the test piece was measured using the vernier caliper. The setting rate under constant load (S) was calculated using the following calculating formula:

S(%)=[(L2−100)/100]×100

L2: Gauge distance in ten minutes after the test piece was unloaded (mm)

In a test for determining the combustibility (a burning test), Example 1 and Control were cut out lengthwise and widthwise, so as to form two different types of (lengthwise and widthwise) rectangular test pieces each having a width of 100 mm and a length of 350 mm. Thereafter, the test pieces thus formed were left for at least 24 hours in an atmosphere that is maintained in temperatures of 20±5° C. and humidity of 50±5% RH. Each of the test pieces was then placed in a cabinet while they are maintained horizontally via a U-shaped clamp. The cabinet had a width of 380±5 mm, a length of 205±5 mm and a height of 355±5 mm and had vent ports that were formed in top and bottom walls thereof. The cabinet was placed in an atmosphere that is maintained in temperatures of 20±5° C. and humidity of 65±20% RH. A longitudinal end periphery of the test piece was heated for fifteen (15) seconds with a gas burner, so as to burn the test piece with a flame. At this time, the gas burner was positioned such that a distance between a heated portion of the test piece and a gas burner nozzle can be set to 19 mm. In this test, the test piece was observed as to whether the flame can be put out before the flame reaches a predetermined longitudinal distance from the heated portion. The combustibility of the test piece was determined as “noncombustible” when the flame was put out before the flame reaches a longitudinal distance of 38 mm from the heated portion.

Results of the initial inherent property test are shown in Table 1.

TABLE 1

| | | Control | Example 1 |
|---|---|---|---|
| Electrically Conductive Agent | | — | 0.8 |
| Application Amount (g/m²) | | | |
| Volume Resistivity Value (Ω · cm) | | 3.3E+14 | 7.4E+11 |
| Tensile Strength (N/50 mm) | Lengthwise | 1536 | 1595 |
| | Widthwise | 1299 | 1306 |
| Extension Rate Under Constant Load (%) | Lengthwise | 3.1 | 2.9 |
| | Widthwise | 2.5 | 4.1 |
| Setting Rate Under Constant Load (%) | Lengthwise | 0.1 | 0.1 |
| | Widthwise | 0.1 | 0.1 |
| Combustibility (Burning Test) | | Non combustible | Non combustible |

As shown in Table 1, Example 1 may have a volume resistivity value lower than Control. This means that the covering material constructed of the base material that is applied with the electrically conductive agent (the copolymers of PET and PEG) may have the increased electrical conductivity, so as to have the increased antistatic performance. Further, with regard to the tensile strength, the extension rate under constant load, the setting rate under constant load, and the combustibility, Example 1 has the substantially same values as Control. This means that the electrically conductive agent applied to the base material does not decrease or deteriorate the inherent properties of the covering material. These results demonstrate that the covering material constructed of the base material applied with the copolymers of PET and PEG can be effectively prevented from generating static charge without decreasing the inherent properties thereof. Therefore, it is considered that the present covering material has better total performance than the non-treated covering material.

### Test of Resistance to Performance Deterioration by Friction

In a test of resistance to performance deterioration of the covering material by friction, four example covering materials (Examples 2-5) were prepared in the same manner as the initial inherent property test. However, Examples 2-5 were prepared by utilizing four fabric pieces. Examples 2-5 thus prepared respectively had electrically conductive agent application amounts of 0.2 g/m², 0.5 g/m², 0.8 g/m² and 1.6 g/m².

With regard to Examples 2-5, volume resistivity values were determined in the same manner as the initial inherent property test. The determined values will be referred to as initial volume resistivity values.

Further, each of Examples 2-5 was applied with surface friction. In particular, each of Examples 2-5 was rubbed with a reciprocating rubbing body that is loaded with 9.8±0.0098 N. The rubbing body was reciprocated with a travel of 140 mm for 10,000 times at a rate of 60±10 times/minute. Thereafter, with regard to Examples 2-5, the volume resistivity values were determined again. The determined values will be referred to as after-friction volume resistivity values.

With regard to Examples 2-5, rates of increase of the volume resistivity values after application of the surface friction were calculated by dividing the after-friction volume resistivity values by the initial volume resistivity values.

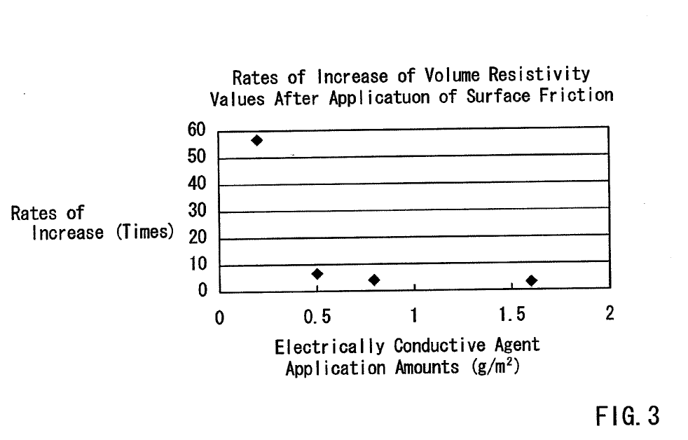

Results are shown in Table 2 and FIG. 3.

TABLE 2

| | Example 2 | Example 3 | Example 4 | Example 5 |
|---|---|---|---|---|
| Electrically Conductive | 0.2 | 0.5 | 0.8 | 1.6 |
| Agent Application | | | | |
| Amount (g/m²) | | | | |
| Initial Volume | 3.6E+12 | 1.6E+12 | 1.2E+12 | 1.5E+12 |
| Resistivity Value | | | | |
| (Ω · cm) | | | | |
| After-Friction Volume | 2.1E+14 | 1.2E+13 | 5.4E+12 | 6.5E+12 |
| Resistivity Value | | | | |
| (Ω · cm) | | | | |
| Rate of Increase of | 58.3 | 7.3 | 4.5 | 4.4 |
| Volume Resistivity | | | | |
| Value (Times) | | | | |

As shown in Table 2, each of Examples 2-5 may have a volume resistivity value lower than Control (Table 1). This means that each of Examples 2-5 may have the increased electrical conductivity compared with Control, so as to have the increased antistatic performance. Further, each of Examples 3-5 may have a low rate of increase of the volume resistivity value after application of the surface friction. This means that the covering material having the electrically conductive agent application amount not less than 0.5 g/m² can maintain the increased antistatic performance even after the surface friction are applied thereto. In particular, each of Examples 4 and 5 may have an extremely low rate of increase of the volume resistivity value after application of the surface friction. This means that the covering material having the electrically conductive agent application amount not less than 0.8 g/m² can reliably maintain the increased antistatic performance even after the surface friction are applied thereto. These results demonstrate that the covering material having the electrically conductive agent application amount not less than 0.5 g/m², more preferably, not less than 0.8 g/m², can be effectively prevented from generating static charge for a long period of time.

### Color Migration Test

In a color migration (staining) test of the covering material, five example covering materials (Examples 6-10) were prepared in the same manner as the initial inherent property test. However, in this test, five fabric pieces impregnated with the electrically conductive agent were dried at different drying temperatures (90° C., 100° C., 110° C., 120° C. and 130° C.) for 90 seconds, thereby forming Examples 6-10 each having the electrically conductive agent application amount of 0.8 g/m². Also, one control covering material (Control) was prepared in the same manner as the initial inherent property test.

In order to evaluate color migration properties of the Examples 6-10, each of Examples 6-10 and Control was cut out, so as to form three (first to third) rectangular test pieces each having a width of 70 mm and a length of 70 mm. Also, a plurality of white cotton clothes having a width of 50 mm and a length of 50 mm were prepared. In addition, an artificial acid perspiration liquid, an artificial alkaline perspiration liquid and distilled water were formulated.

A first examination was performed using the first test pieces of Examples 6-10 and Control and the artificial acid perspiration liquid. In the first examination, each of the five cotton clothes was dipped in the artificial acid perspiration liquid for ten (10) minutes and was then placed on a surface of each of the first test pieces of Examples 6-10 and Control without being squeezed. The first test piece applied with the cotton cloth was wrapped with an aluminum foil as is and was then disposed on a horizontal test stand. Thereafter, a cylindrical weight having a diameter of 40 mm and weighing 1 kg was placed on the first test piece covered by the cotton cloth. At this time, the cylindrical weight was previously heated to 40±2° C. Subsequently, the first test piece covered by the cotton cloth was placed in a dryer controlled to 40±2° C. together with the test stand and was maintained for 60 minutes. That is, the first test piece covered by the cotton cloth was left for 60 minutes while the cotton cloth was pressed to the first test piece via the weight. After 60 minutes, the cotton cloth was peeled off from the first test piece and was visually observed for appearance thereof in order to determine occurrence of color staining. The appearance of the cotton cloth was evaluated based on a gray scale in accordance with Japanese Industrial Standard (JIS L0805). Evaluation standards (grades) were Grade 1 (the greatest color migration property) to Grade 5 (the least color migration property). As a result of visual observation, the color migration property of the cotton cloth applied to each of the first test pieces was determined as Grade 4.5 or Grade 5. Generally, when the color staining was not substantially observed, the color migration property was determined as Grade 5. Further, when the color staining was slightly observed, the color migration property was determined as Grade 4.5.

Next, a second examination was performed using the second test pieces of Examples 6-10 and Control and the artificial alkaline perspiration liquid in the same manner as the first examination. As a result of visual observation, the color migration property of the cotton cloth applied to each of the second test pieces was determined as Grade 4.5 or Grade 5.

Further, a third examination was performed using the third test pieces of Examples 6-10 and Control and the distilled water in the same manner as the first examination. As a result of visual observation, the color migration property of the cotton cloth applied to each of the third test pieces was determined as Grade 4.5 or Grade 5.

Results of the color migration test are shown in Table 3. Further, each of the grades described in Table 3 correspond to the least grade in the first to third examinations.

TABLE 3

| | Control | Example 6 | Example 7 | Example 8 | Example 9 | Example 10 |
|---|---|---|---|---|---|---|
| Drying Temperature (° C.) | — | 90 | 100 | 110 | 120 | 130 |
| Color Migration Property | 5 | 5 | 5 | 5 | 4.5 | 4.5 |
| (Grade) | | | | | | |

As shown in Table 3, each of Examples 6-10 may have Grade 4.5 or more. This means that each of Examples 6-10 may have a reduced color migration property. In particular, each of Examples 6-8 may have the highest grade (Grade 5). This means that each of Examples 6-8 may have the least color migration property. These results demonstrate that the covering material constructed of the base material that was dried at drying temperatures not greater than 110° C. may have the least color migration property.

What is claimed is:

1. A covering material for a vehicle seat, comprising:
a base material constructed of polyester fiber containing fabric; and
an electrically conductive agent applied to the base material,
wherein the electrically conductive agent comprises a copolymer of polyethylene terephthalate and polyethyleneglycol.

2. The covering material as defined in claim 1, wherein the electrically conductive agent is applied to the base material at a rate not less than 0.5 g/m² as solid content.

3. The covering material as defined in claim 1, wherein the electrically conductive agent is applied to the base material by dipping the base material into a solution containing the electrically conductive agent as an effective ingredient, and wherein the base material is dried at a drying temperature between 60-110° C.

4. A method of manufacturing a covering material for a vehicle seat, comprising the steps of:
dipping a base material constructed of polyester fiber containing fabric into a solution containing an electrically conductive agent as an effective ingredient, thereby applying the electrically conductive agent to the base material; and
drying the base material at a drying temperature between 60-110° C.,
wherein the electrically conductive agent comprises a copolymer of polyethylene terephthalate and polyethyleneglycol.
